(19) United States
(12) Patent Application Publication
(10) Pub. No.: US 2024/0120797 A1
(43) Pub. Date: Apr. 11, 2024

(54) MOTOR AND MOTOR UNIT

(71) Applicant: YAMAHA HATSUDOKI KABUSHIKI KAISHA, Iwata-shi, Shizuoka (JP)

(72) Inventors: Takuro KAMICHIKA, Shizuoka (JP); Shinichi KUROSAWA, Shizuoka (JP); Shogo TANINO, Shizuoka (JP)

(21) Appl. No.: 18/542,824

(22) Filed: Dec. 18, 2023

Related U.S. Application Data
(63) Continuation of application No. PCT/JP2022/014119, filed on Mar. 24, 2022.

(30) Foreign Application Priority Data
Jun. 21, 2021 (JP) 2021-102789

(51) Int. Cl. H02K 5/20; F16H 57/04; H02K 7/116; H02K 9/19

(52) U.S. Cl. CPC H02K 5/203; F16H 57/045; F16H 57/0476; H02K 7/116; H02K 9/19

(57) ABSTRACT

A motor unit includes a motor and a speed reducer. The motor includes a case including a stator housing, a first motor cover, and a second motor cover. Outside the stator housing, a first external pipe includes an outward oil path, a second external pipe includes a return oil path, and the first external pipe and the second external pipe are held by the first motor cover and the second motor cover. A rotor is provided inside the case and held by the first motor cover and the second motor cover. A stator core is provided inside the case and fixed to the stator housing by a shrink fit. The speed reducer includes an oil reservoir which communicates with the return oil path.

### CROSS REFERENCE TO RELATED APPLICATIONS

This application claims the benefit of priority to Japanese Patent Application No. 2021-102789 filed on Jun. 21, 2021 and is a Continuation application of PCT Application No. PCT/JP2022/014119 filed on Mar. 24, 2022. The entire contents of each application are hereby incorporated herein by reference.

### BACKGROUND OF THE INVENTION

### 1. Field of the Invention

The present invention relates to motors and motor units, and more specifically to motors and motor units used in electric vehicles.

### 2. Description of the Related Art

As an example which is pertinent to conventional techniques of this kind, JP-A 2021-52523 discloses a driving apparatus. The driving apparatus includes a motor having a rotor and a stator radially outside the rotor, a housing which houses the motor, and a cooling medium flow path passing inside the housing and including a cooling medium. The housing has an inner circumferential surface, the stator has an outer circumferential surface, and the surfaces are radially opposed to each other. The cooling medium flow path includes an injection hole for injection of the cooling medium between the housing's inner circumferential surface and the stator's outer circumferential surface, and a guide flow path located between the housing's inner circumferential surface and the stator's outer circumferential surface. The guide flow path is a groove which is at least in one of the housing's inner circumferential surface and the stator's outer circumferential surface, and extends in a circumferential direction.

JP-A 2021-52523 does not provide a simple structure between the housing and the stator, or a size reduction of an outer shape of the housing.

### SUMMARY OF THE INVENTION

Therefore, preferred embodiments of the present invention simplify the structure between stator housings and stator cores thus providing motors and motor units including stator housings having a reduced size.

According to a preferred embodiment of the present invention, a motor includes a case including a stator housing, a first motor cover at an output end of the stator housing, and a second motor cover at a non-output end of the stator housing; an outward oil path outside the stator housing and connecting the first motor cover and the second motor cover; a return oil path outside the stator housing and lower than the outward oil path to connect the first motor cover and the second motor cover; a rotor inside the case and held by the first motor cover and the second motor cover; and a stator core inside the case and radially outside the rotor and fixed to the stator housing.

In a preferred embodiment of the present invention, both of the outward oil path and the return oil path are not between the stator housing and the stator core, but are outside the stator housing to connect the first motor cover and the second motor cover. Also, the stator core is fixed to the stator housing. Therefore, by simplifying the structure between the stator housing and the stator core, it is possible to reduce the size of the stator housing.

Preferably, the stator core is fixed to the stator housing by a shrink fit. In this case, the outer circumferential surface of the stator core and the inner circumferential surface of the stator housing are in surface contact in the circumferential direction, thus making it possible to hold the stator core more firmly by the stator housing.

Further preferably, the first motor cover includes a first oil path connected to the outward oil path to supply oil to the outward oil path, and a second oil path branched from the first oil path to supply oil into the case. In this case, since it is possible to supply oil to the outward oil path via the first oil path inside the first motor cover and into the case via the second oil path, it is possible to supply oil to the rotor and the stator core smoothly while making effective use of the first motor cover as an oil supply.

Further, preferably, the second motor cover includes a third oil path connected to the outward oil path to supply oil from the outward oil path into the case. In this case, it is possible to supply oil from the outward oil path into the case via the third oil path inside the second motor cover and to supply oil to the rotor and the stator core smoothly while making effective use of the second motor cover as an oil supply.

Preferably, an outer circumferential surface of the stator housing includes no ribs from the output end to the non-output end. In this case, it is possible to reduce the weight and size of the stator housing.

Further preferably, the motor further includes a first external pipe including the outward oil path and held by the first motor cover and the second motor cover, and a second external pipe including the return oil path and held by the first motor cover and the second motor cover. In this case, it is possible to provide the outward oil path and the return oil path easily outside the stator housing.

Further, preferably, the outward oil path has a smaller cross sectional area than the return oil path. In this case, it is possible to discharge oil to the outside smoothly without the oil stagnating inside the return oil path.

According to another preferred embodiment of the present invention, a motor unit includes the above described motor, and a speed reducer on a side of the first motor cover to slow rotation of the rotor and including an oil reservoir in communication with the return oil path.

In a preferred embodiment of the present invention, it is possible to supply oil to the speed reducer smoothly.

It should be noted here that in preferred embodiments of the present invention, “output end of the stator housing” refers to an axial end of the stator housing from which the motor output is taken off.

“Non-output end of the stator housing” refers to an axial end of the stator housing from which the motor output is not taken off (an axial end on a side away from the output end). According to preferred embodiments of the present invention, it is possible to reduce the size of the stator housing by simplifying the structure between the stator housing and the stator core.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front perspective view which shows a motor unit according to a preferred embodiment of the present invention.

FIG. 2 is a rear perspective view which shows the motor unit in FIG. 1.

FIG. 3 is a right side view which shows the motor unit in FIG. 1.

FIG. 4 is a left side view which shows the motor unit in FIG. 1.

FIG. 5 is an illustrative sectional view which shows the motor unit in FIG. 1.

FIG. 6 is a plan view which shows a gasket of the motor unit.

### DETAILED DESCRIPTION OF THE PREFERRED EMBODIMENTS

Hereinafter, preferred embodiments of the present invention will be described with reference to the drawings.

A motor unit 10 according to a preferred embodiment of the present invention is suitably applied to an electric vehicle. The terms front and rear, left and right, and up and down used in the preferred embodiments of the present invention are defined based on a direction in which a rotor 40 (which will be described below) extends in a left-right direction, and a direction from a motor 12 (which will be described below) toward an inverter 16 (which will be described later) extends in a rearward direction. In the drawings, “Fr” indicates forward, “Rr” indicates rearward, “R” indicates rightward, “L” indicates leftward, “U” indicates upward, and “Lo” indicates downward.

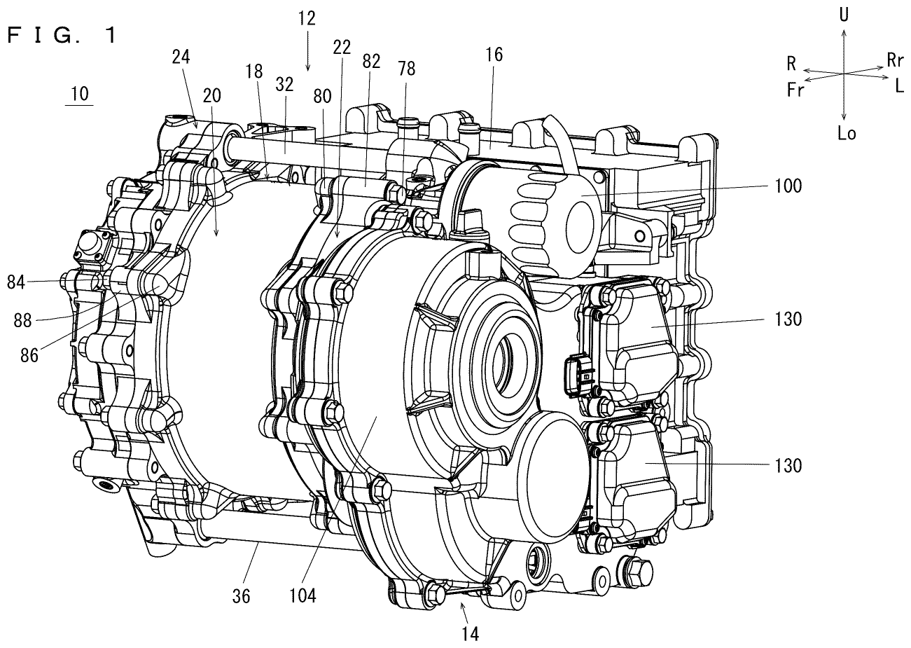

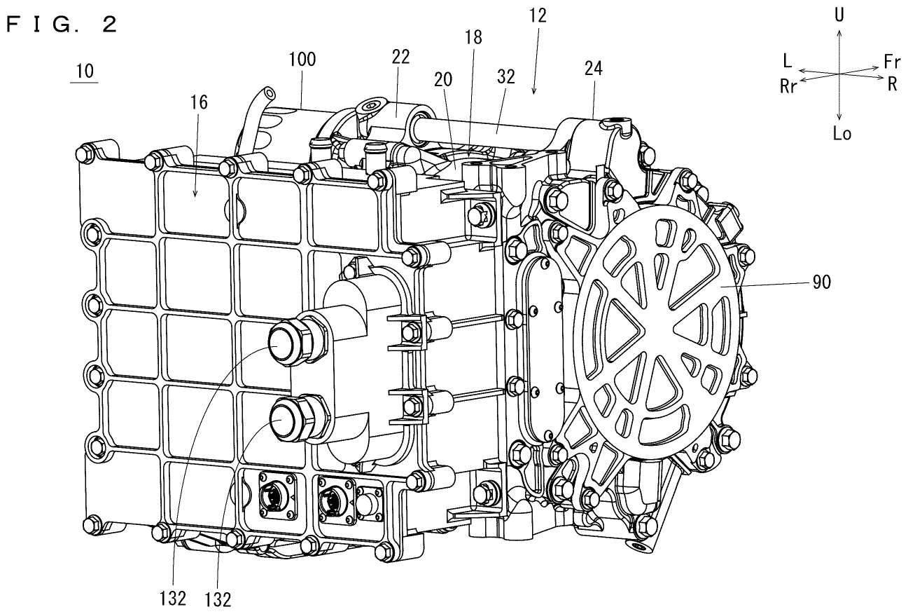

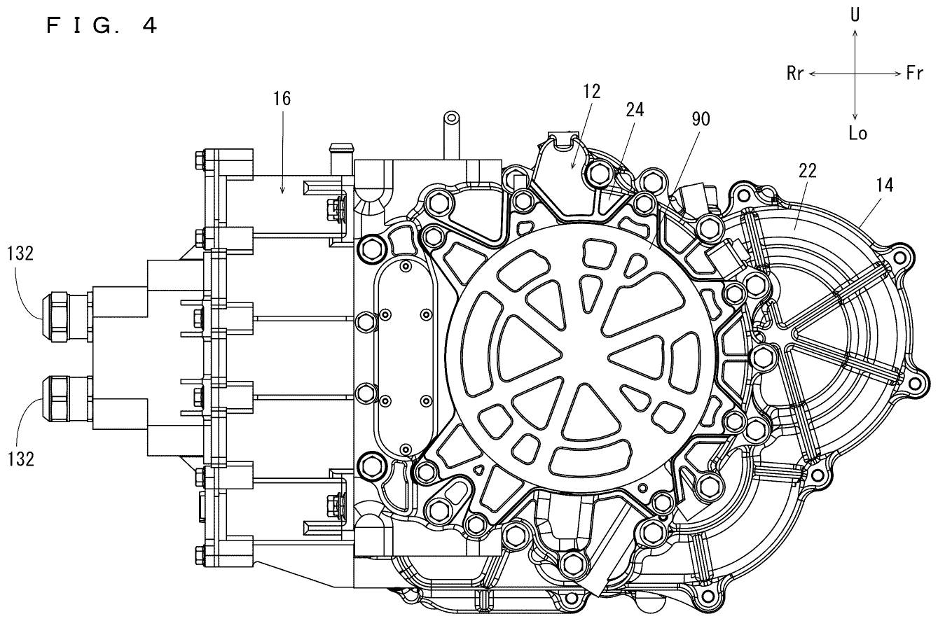

Referring to FIG. 1 through FIG. 4, the motor unit 10 is a mechatronic integrated unit including the motor 12, a speed reducer 14, and an inverter 16. The speed reducer 14 is provided on a side (left side in the present preferred embodiment) of the motor 12, while the inverter 16 is provided behind the motor 12 and the speed reducer 14.

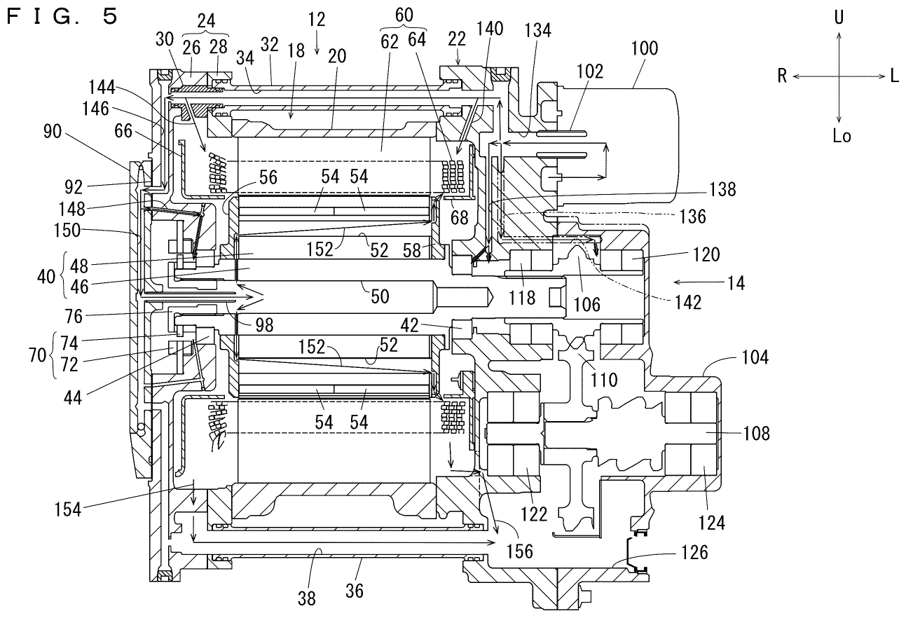

Referring also to FIG. 5, the motor 12 includes a case 18. The case 18 has a three-tier structure, and includes a stator housing 20, a first motor cover 22 provided at an output end of the stator housing 20, and a second motor cover 24 provided at a non-output end of the stator housing 20. The second motor cover 24 includes a cover main body 26, and a pipe holder 28 attached to the cover main body 26. A branched portion 30 is provided between the cover main body 26 and the pipe holder 28.

Outside the stator housing 20, a first external pipe 32 is held by the first motor cover 22 and the second motor cover 24. The first external pipe 32 is separate from the stator housing 20, located slightly spaced away from the stator housing 20, and sandwiched by the first motor cover 22 and the second motor cover 24. The first external pipe 32 includes an outlet end held by the pipe holder 28 and connected with the branched portion 30. Inside the first external pipe 32, an outward oil path 34 extends between the first motor cover 22 and the second motor cover 24. Outside the stator housing 20 at a position lower than the first external pipe 32, a second external pipe 36 is held by the first motor cover 22 and the second motor cover 24. The second external pipe 36 is separate from the stator housing 20, located slightly spaced away from the stator housing 20, and sandwiched by the first motor cover 22 and the second motor cover 24. The second external pipe 36 includes an inlet end held by the pipe holder 28. Inside the second external pipe 36, a return oil path 38 extends between the first motor cover 22 and the second motor cover 24. The return oil path 38 is provided at a lower position than the outward oil path 34. The outward oil path 34 and the return oil path 38 are columnar shaped. Preferably, the outward oil path 34 has a smaller cross sectional area than the return oil path 38. In other words, preferably, an inner diameter of the first external pipe 32 is smaller than an inner diameter of the second external pipe 36.

The rotor 40 is provided inside the case 18. The rotor 40 is held rotatably by the first motor cover 22 and the second motor cover 24 via motor bearings 42, 44. The rotor 40 includes a rotor shaft 46 and a rotor core 48. The rotor shaft 46 includes an axially extending hollow portion 50. The rotor core 48 includes a plurality of rotor core holes 52 and a plurality of magnets 54. End plates 56, 58 are disposed at two axial ends of the rotor core 48.

Inside the case 18, a stator 60 is provided radially outside the rotor 40. The stator 60 includes a stator core 62 provided radially outside the rotor 40 and is fixed to the stator housing 20, and a stator coil 64 which is wound around the stator core 62. The stator core 62 is fixed to the stator housing 20 by a shrink fit, for example. Coil end covers 66, 68 cover the two axial ends of the stator coil 64, i.e., to cover the coil ends.

Between the second motor cover 24 and the rotor shaft 46, a resolver 70 is provided to detect a rotating angle of the rotor shaft 46. The resolver 70 includes a resolver stator 72 attached to the second motor cover 24, and a resolver rotor 74 attached to the rotor shaft 46. The resolver rotor 74 is fixed to a rear end of the rotor shaft 46 by, for example, a bolt 76 which has a generally hat-shaped portion.

Referring to FIG. 1, the stator housing 20 and the first motor cover 22 are connected to each other by a plurality of bolts 78, for example. Each bolt 78 is threaded into a boss 80 provided on an output end in an outer circumferential surface of the stator housing 20, and a boss 82 provided on an outer circumferential portion of the first motor cover 22. The stator housing 20 and the second motor cover 24 are connected to each other by a plurality of bolts 84, for example. Each bolt 84 is threaded into a boss 86 provided on a non-output end in an outer circumferential surface of the stator housing 20, and a boss 88 provided on an outer circumferential portion of the second motor cover 24. The bolts 78, 84 are short so that they do not extend from the output end, where the first motor cover 22 is located, to the non-output end, where the second motor cover 24 is located, in the outer circumferential surface of the stator housing 20. Therefore, the bolts 78, 84 do not penetrate the stator housing 20 axially. Also, there are no ribs (e.g., locally formed thick-walled portions) in the outer circumferential surface of the stator housing 20 from the output end, where the first motor cover 22 is located, to the non-output end, where the second motor cover 24 is located.

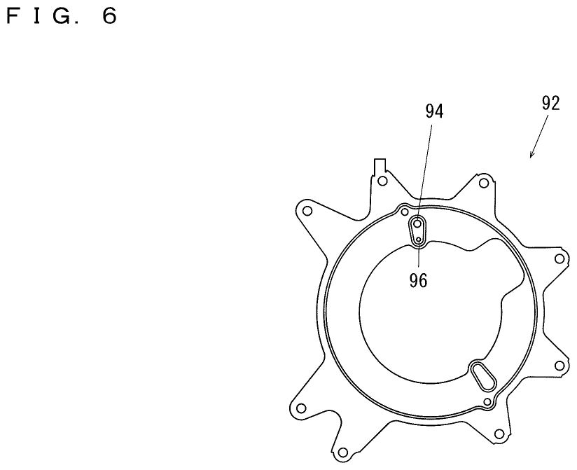

Referring to FIG. 5, a cover 90 is provided on a side of the second motor cover 24. A gasket 92 is located between the second motor cover 24 and the cover 90. Referring to FIG. 6, the gasket 92 has an annular or substantially annular shape, and includes through-holes 94, 96 in communication with the oil paths. A pipe 98 extending into the hollow portion 50 of the rotor shaft 46 is attached at a center portion of the cover 90.

In an outer surface of the first motor cover 22, an oil filter 100 is provided to filer oil which is to be supplied into the case 18. The oil filter 100 is supplied with oil from an oil cooler (not illustrated) provided outside the motor unit 10. The oil filter 100 and the first motor cover 22 are connected with each other by a union bolt 102, for example.

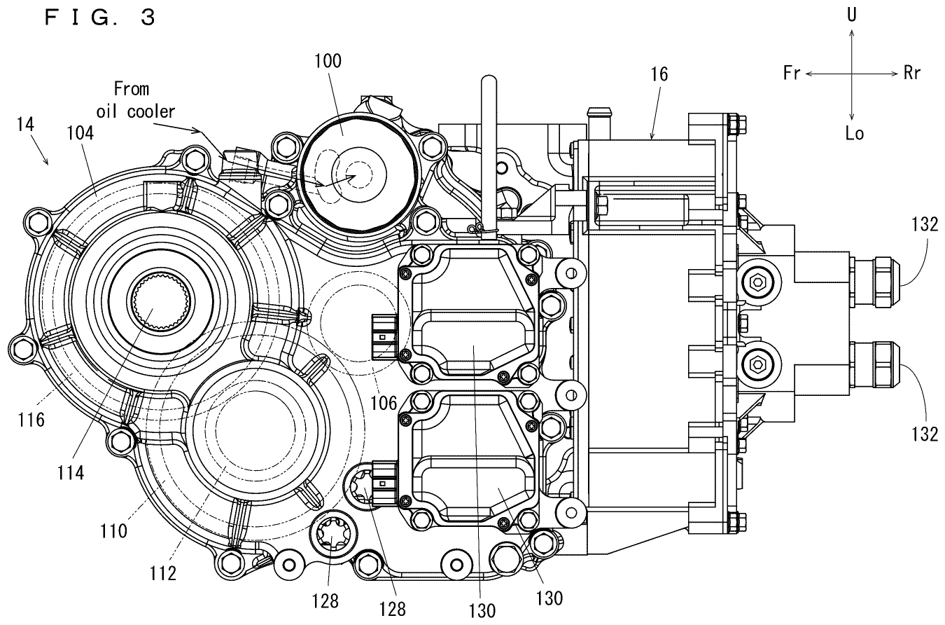

The speed reducer 14 is provided on a side (left side in the present preferred embodiment) of the first motor cover 22 in order to slow rotation of the rotor. The speed reducer 14 includes a gear cover 104 provided on a side of the first motor cover 22. Referring to FIG. 3 and FIG. 5, the gear cover 104 includes therein an input gear 106, an intermediate shaft 108, intermediate gears 110, 112, an output shaft 114, and an output gear 116. The intermediate shaft 108 and the output shaft 114 are parallel or substantially parallel to the rotor shaft 46. The input gear 106 is attached to a tip portion of the rotor shaft 46, and is supported rotatably by the first motor cover 22 and the gear cover 104 via input gear bearings 118, 120. The intermediate shaft 108 is supported rotatably by the first motor cover 22 and the gear cover 104 via intermediate gear bearings 122, 124. The intermediate gears 110, 112 are both attached to the intermediate shaft 108. The intermediate gear 110 meshes with the input gear 106. The intermediate gear 112 meshes with the output gear 116. The output shaft 114 is supported rotatably by the first motor cover 22 and the gear cover 104 via unillustrated bearings. The output gear 116 is attached to the output shaft 114. The gear cover 104 covers an outer surface of the first motor cover 22 to define an oil reservoir 126 that connects to the return oil path 38. In other words, the oil reservoir 126 is inside the speed reducer 14. The oil reservoir 126 stores oil from the case 18 and oil from the gear cover 104.

The gear cover 104 is provided with two oil level gauges 128 to detect an amount of oil inside the oil reservoir 126. Also, the gear cover 104 is provided with two oil pumps 130 to supply oil from inside the oil reservoir 126 to the external oil cooler.

The inverter 16 is connected with a battery (not illustrated) via connecting terminals 132, converts a direct current from the battery into an alternating current, and supplies the current to the motor 12.

The motor unit 10 described thus far includes the following oil paths.

Referring to FIG. 5, the first motor cover 22 includes an oil path 134 connected to the outward oil path 34 to supply oil from the oil filter 100 to the outward oil path 34, and oil paths 136, 138, 140 branching from the oil path 134. The oil path 136 is connected to an oil path 142 inside the speed reducer 14 to supply oil to the input gear bearing 120. Oil from the oil path 138 is supplied to the motor bearing 42 and the input gear bearing 118. Oil from the oil path 140 is supplied to the coil end of the stator coil 64. The oil is supplied into the case 18 via the oil paths 138, 140. Oil from the oil path 134 flows through the outward oil path 34 and is supplied to the second motor cover 24.

The second motor cover 24 includes oil paths 144, 146, 148. Oil which flows through the outward oil path 34 and is supplied to the second motor cover 24 is divided by the branched portion 30, supplied to the coil end of the stator coil 64 via the oil path 144, and sent toward the cover 90 via the oil path 146. The cover 90 includes an oil path 150. The oil path 150 connects the oil paths 146 and 148 with each other. In other words, the oil path 146 and the oil path 150 communicate with each other via the through-hole 94 of the gasket 92, while the oil path 150 and the oil path 148 communicate with each other via the through-hole 96 of the gasket 92. Therefore, the oil paths 146 and 148 of the second motor cover 24 communicate with each other via the oil path 150 of the cover 90, and oil from the oil path 146 is supplied to the motor bearing 44 and its surroundings via the oil paths 150, 148. Also, the oil path 150 connects, via the pipe 98, the hollow portion 50 of the rotor shaft 46 and the rotor core holes 52 with an oil path 152 which leads to the coil end of the stator coil 64. Therefore, oil from the oil path 150 is supplied to the coil end of the stator coil 64 via the oil path 152. The oil from the outward oil path 34 is supplied into the case 18 via the second motor cover 24 and the cover 90.

Oil which is supplied to the coil end of the stator coil 64 is then supplied to the oil reservoir 126 via an oil path 154 and the return oil path 38, or via an oil path 156 of the first motor cover 22.

In a preferred embodiment, the oil path 134 corresponds to the first oil path. The oil paths 138, 140 correspond to the second oil path. The oil paths 144, 146, 148 correspond to the third oil path.

According to the motor unit 10 described thus far, both of the outward oil path 34 and the return oil path 38 are not between the stator housing 20 and the stator core 62, but are outside the stator housing 20 to connect the first motor cover 22 and the second motor cover 24. Also, the stator core 62 is fixed to the stator housing 20. Therefore, by simplifying the structure between the stator housing 20 and the stator core 62, it is possible to reduce the size of the stator housing 20.

Since the stator core 62 is fixed to the stator housing 20 by a shrink fit, for example, the outer circumferential surface of the stator core 62 and the inner circumferential surface of the stator housing 20 are in surface contact in the circumferential direction, making it possible to hold the stator core 62 more firmly by the stator housing 20.

Since it is possible to supply oil to the outward oil path 34 via the oil path 134 inside the first motor cover 22 and into the case 18 via the oil paths 138, 140, it is possible to supply oil to the rotor 40 and the stator core 64 smoothly while making effective use of the first motor cover 22 as an oil supply.

It is possible to supply oil from the outward oil path 34 into the case 18 via the oil paths 144, 146, 148 inside the second motor cover 24 and to supply oil to the rotor 40 and the stator core 64 smoothly while making effective use of the second motor cover 24 as an oil supply.

Since the stator housing 20 has no ribs from the output end to the non-output end in its outer circumferential surface, it is possible to reduce the weight and size of the stator housing 20.

By using the first external pipe 32 which includes the output oil path 34 and is held by the first motor cover 22 and the second motor cover 24, and the second external pipe 36 which includes the return oil path 38 and is held by the first motor cover 22 and the second motor cover 24, it is possible to provide the outward oil path 34 and the return oil path 38 easily outside the stator housing 20.

The outward oil path 34 having a smaller sectional area than that of the return oil path 38 makes it possible to discharge oil to the outside smoothly without the oil stagnating inside the return oil path 38.

Since the speed reducer 14 includes the oil reservoir 126 which communicates with the return oil path 38, it is possible to supply oil to the speed reducer 14 smoothly.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a case including a stator housing, a first motor cover at an output end of the stator housing, and a second motor cover at a non-output end of the stator housing;
an outward oil path outside the stator housing and connecting the first motor cover and the second motor cover;
a return oil path outside the stator housing and lower than the outward oil path to connect the first motor cover and the second motor cover;
a rotor inside the case and held by the first motor cover and the second motor cover; and
a stator core inside the case and radially outside the rotor and fixed to the stator housing.

2. The motor according to claim 1, wherein the stator core is fixed to the stator housing by a shrink fit.

3. The motor according to claim 1, wherein the first motor cover includes a first oil path connected to the outward oil path to supply oil to the outward oil path, and a second oil path branched from the first oil path to supply oil into the case.

4. The motor according to claim 1, wherein the second motor cover includes a third oil path connected to the outward oil path to supply oil from the outward oil path into the case.

5. The motor according to claim 1, wherein an outer circumferential surface of the stator housing includes no ribs from the output end to the non-output end.

6. The motor according to claim 1, further comprising:
a first external pipe including the outward oil path and held by the first motor cover and the second motor cover; and
a second external pipe including the return oil path and held by the first motor cover and the second motor cover.

7. The motor according to claim 6, wherein the outward oil path has a smaller cross sectional area than the return oil path.

8. A motor unit comprising:
the motor according to claim 1; and
a speed reducer on a side of the first motor cover to slow rotation of the rotor, and including an oil reservoir connected to the return oil path.
